(19) United States
(12) Patent Application Publication
(10) Pub. No.: US 2026/0169911 A1
(43) Pub. Date: Jun. 18, 2026

(54) STORAGE DEVICE AND STORAGE SYSTEM

(71) Applicant: SAMSUNG ELECTRONICS CO., LTD., Suwon-si (KR)

(72) Inventor: Sooyoung JI, Suwon-si (KR)

(73) Assignee: SAMSUNG ELECTRONICS CO., LTD., Suwon-si (KR)

(21) Appl. No.: 19/250,909

(22) Filed: Jun. 26, 2025

(30) Foreign Application Priority Data
Dec. 17, 2024 (KR) 10-2024-0188170

(51) Int. Cl. G06F 12/02

(52) U.S. Cl. CPC G06F 12/0238; G06F 2212/7201

(57) ABSTRACT

A storage device includes: a plurality of memory groups respectively including a plurality of non-volatile memories; a storage controller configured to control the plurality of memory groups; and a plurality of channels respectively connecting the storage controller and the plurality of memory groups, wherein the storage controller is configured to: generate one or more vector data items by performing vector embedding on a raw data item, and store the raw data item and the one or more vector data items respectively in different memory groups among the plurality of memory groups.

### CROSS-REFERENCE TO RELATED APPLICATION

This application claims benefit of priority to Korean Patent Application No. 10-2024-0188170, filed on Dec. 17, 2024, in the Korean Intellectual Property Office, the disclosure of which is incorporated herein by reference in its entirety.

### BACKGROUND

The present disclosure relates to a storage device and a storage system.

As large language model (LLM) technology utilizing retrieval-augmented generation (RAG) is developed, vector database technology, which may be a core technology of the RAG, is attracting attention. A vector database may be designed to store and search vector data, which may be a high-dimensional mathematical expression of raw data. For example, a distance between vectors of raw data may be shortened as meanings of the raw data are similar. Using the vector database, data similar to a given query may be easily found.

A size of a storage space required to store the vector data together with the raw data in a database system may increase, and a large amount of vector data may have to be read to find data similar to a query. Therefore, a computation amount of a central processing unit (CPU) of the database system and an amount of data input/output between the CPU and the storage device may increase.

### SUMMARY

Provided is a storage device offloading a computation amount of a CPU of a database system, reducing an amount of data input/output, and further improving performance of data search.

According to an aspect of the disclosure, A storage device includes: a plurality of memory groups respectively including a plurality of non-volatile memories; a storage controller configured to control the plurality of memory groups; and a plurality of channels respectively connecting the storage controller and the plurality of memory groups, wherein the storage controller is configured to: generate one or more vector data items by performing vector embedding on a raw data item, and store the raw data item and the one or more vector data items respectively in different memory groups among the plurality of memory groups.

According to an aspect of the disclosure, a method performed by a storage device, includes: generating one or more vector data items by performing vector embedding on a raw data item; and storing the raw data item and the one or more vector data items respectively in different memory groups among a plurality of memory groups respectively including a plurality of non-volatile memories.

The method further includes: defining a logical address space for at least one of the plurality of memory groups, and allocating a same logical address to the raw data item and the one or more vector data items that are associated with the raw data item.

The method further includes: storing a first mapping table including a mapping of the plurality of memory groups and a plurality of data types, wherein the plurality of data types include a raw data type and one or more vector data types.

The method further includes storing a second mapping table for mapping logical addresses and physical addresses of the plurality of memory groups.

The one or more vector data items include at least one of a vector, a link to an associated vector of the vector, a distance between the vector and the associated vector, and a gradient between the vector and the associated vector.

The one or more vector data items include a plurality of vector data items having a plurality of different vector data types.

The raw data item includes data having different attributes, and wherein the plurality of different vector data types include a vector for data having different attributes.

The method further includes simultaneously writing the raw data item and the one or more vector data items by controlling the plurality of memory groups.

The method further includes, in response to a query from a host, simultaneously reading the raw data item and the one or more vector data items by controlling the plurality of memory groups.

The method further includes storing the raw data item and the one or more vector data items, obtained from the plurality of memory groups, in a buffer memory, and, in a state that the one or more vector data items correspond to a neighboring vector neighboring a query vector corresponding to the query, outputting the raw data item stored in the buffer memory to the host.

According to an aspect of the disclosure, a storage device includes: a plurality of memory groups respectively including a plurality of non-volatile memories; a storage controller configured to control the plurality of memory groups; and a plurality of channels respectively connecting the storage controller and the plurality of memory groups, wherein the storage controller is configured to: by performing vector embedding on a raw data item to generate a vector, generate a plurality of vector data items connecting the vector and a different vector based on different vector indexing methods, and store the raw data item and the plurality of vector data items respectively in different memory groups among the plurality of memory groups.

According to an aspect of the disclosure, a method performed by a storage device, includes: performing vector embedding on a raw data item to generate a vector, generating a plurality of vector data items connecting the vector and a different vector based on different vector indexing methods, and storing the raw data item and the plurality of vector data items respectively in different memory groups among a plurality of memory groups respectively including a plurality of non-volatile memories.

According to an aspect of the disclosure, a storage system includes: at least one processor configured to perform vector embedding on a raw data item and generate one or more vector data items; a storage device including a plurality of memory groups respectively including a plurality of non-volatile memories; a storage controller configured to control the plurality of memory groups and a plurality of channels respectively connecting the storage controller and the plurality of memory groups, wherein the storage controller is further configured to: receive the raw data item and the one or more vector data items from the at least one processor, and store the raw data item and the one or more vector data items respectively in different memory groups among the plurality of memory groups.

According to an aspect of the disclosure, a method performed by a storage system, includes: performing vector embedding on a raw data item and generating one or more vector data items; receiving the raw data item and the one or more vector data items, and storing the raw data item and the one or more vector data items respectively in different memory groups among a plurality of memory groups including a plurality of non-volatile memories.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 illustrates a large language model (LLM) system according to an embodiment;

FIG. 2 illustrates a storage device according to an embodiment;

FIG. 3 illustrates an example of raw data;

FIGS. 4A and 4B illustrate examples of vectors of different types;

FIGS. 5A and 5B illustrate examples of vector spaces of different types;

FIG. 6 illustrates a first mapping table of a storage device according to an embodiment;

FIGS. 7A and 7B illustrate second mapping tables of a storage device according to an embodiment;

FIG. 8 illustrates a data storage operation of a storage device according to an embodiment;

FIG. 9 illustrates a data search operation of a storage device according to an embodiment;

FIG. 10 illustrates an example of vector data according to an embodiment;

FIG. 11 illustrates a data search process of a storage device according to an embodiment;

FIGS. 12A to 12C illustrate examples of vector databases;

FIG. 13 illustrates a data search method of a storage device according to an embodiment;

FIG. 14 illustrates a vector database system according to an embodiment; and

FIG. 15 illustrates a storage system according to an embodiment.

### DETAILED DESCRIPTION OF EMBODIMENTS

The embodiments described herein are non-limiting example embodiments, and thus, the disclosure is not limited thereto and may be realized in various other forms. As used herein, an expression “at least one of” preceding a list of elements modifies the entire list of the elements and does not modify the individual elements of the list. For example, an expression, “at least one of a, b and c” or “at least one of a, b or c” should be understood as including only a, only b, only c, both a and b, both a and c, both b and c, or all of a, b, and c.

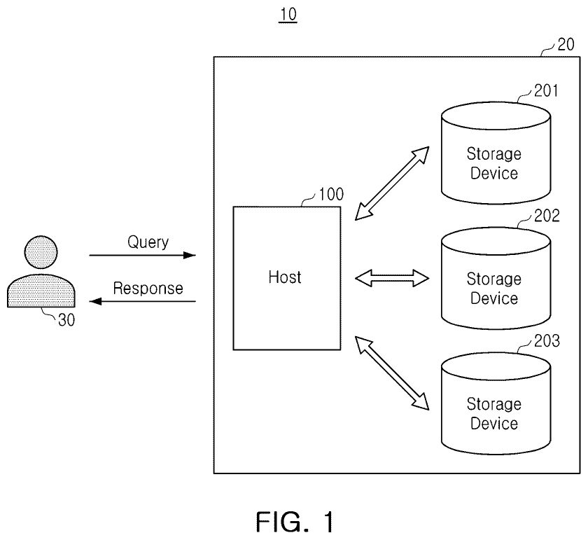

FIG. 1 illustrates a large language model (LLM) system according to an embodiment.

LLM may refer to artificial intelligence (or an artificial intelligence model) that is trained on a large amount of text data set, which aims to understand and generate natural language. LLM may analyze patterns, contexts, and relationships of text, using deep learning, to perform tasks such as translation, summary, answering to a question, and generation of contents.

Although development of LLM has improved natural language processing capabilities, problems may occur, such as hallucinations that generate unfounded information. The hallucinations may arise from the tendency of LLM to generate the most plausible responses, based on probability, rather than accurate information. Retrieval-augmented generation (RAG) may combine knowledge retrieval functions with LLM to generate answers based on prepared data in advance, thereby LLM with RAG may reduce hallucinations and may improve accuracy of responses.

Vector database technology, which may be a core technology of RAG, has attracted attentions in the field of artificial intelligence. A vector database may be designed to store and retrieve vectors, which may be high-dimensional mathematical expressions of raw data. For example, as raw data items have similar meanings to each other, a distance between vectors of the raw data items may be closer. Data similar to a given query may be easily found using the vector database technology.

Referring to FIG. 1, an LLM system 10 may include a vector database system 20 and a user system 30. When the vector database system 20 receives a query from the user system 30, data nearest to the query may be searched based on a ‘query vector’ corresponding to the query. The vector database system 20 may generate a response based on the searched data, and the vector database system 20 may provide the response to the user system 30, as shown in FIG. 1.

In FIG. 1, the vector database system 20 may include a host 100 and a plurality of storage devices 201 to 203.

The host 100 may include at least one core (or a processor) for processing a command. For example, the host 100 may include at least one of an application processor, a microprocessor, a central processing unit (CPU), a processor core, a multi-core processor, a multi-processor, an application-specific integrated circuit (ASIC), and a field programmable gate array (FPGA).

Each or at least one of the storage devices 201 to 203 may include storage media for storing data in response to (or related to) a request from the host 100. For example, at least one of the storage devices 201 to 203 may include at least one of a solid state drive (SSD), an embedded memory, or a removable external memory. When each or at least one of the storage devices 201 to 203 is the SSD, the embedded memory, or the external memory, each or at least one of the storage devices 201 to 203 may further include a non-volatile memory device.

When the storage devices 201 to 203 are SSDs, the storage devices 201 to 203 may be compliant with a non-volatile memory express (NVMe) standard. When the storage devices 201 to 203 are embedded memories or external memories, the storage devices 201 to 203 may be compliant with a universal flash storage (UFS) standard or an embedded multi-media card (eMMC) standard. Each or at least one of the host 100 and the storage devices 201 to 203 may generate a packet according to an adopted standard protocol, and may transmit the same.

The vector database system 20 may analyze the raw data to divide the raw data into a plurality of raw data items, and may generate vector data items based on the raw data items. The raw data items and the vector data items may be stored in at least one of the plurality of storage devices 201 to 203.

When a query is received, the vector database system 20 may analyze the query to generate at least one query vector, may search for a vector most similar to the query vector from the plurality of storage devices 201 to 203, may generate a response with reference to data corresponding to the searched vector, and may output the response.

The vector database system 20 may store vector data corresponding to raw data together with the raw data, and may thus process a large amount of data, as compared to an amount of the raw data. For example, when the vector database system 20 generates and stores several types of vector data corresponding to the raw data, an amount of data stored in the plurality of storage devices 201 to 203 may increase by about ten (10) times compared to an amount of the raw data.

In the related art, when the host 100 stores the raw data and the vector data in a distributed manner in the plurality of storage devices 201 to 203 and searches through all of the plurality of storage devices 201 to 203 to find data corresponding to a query, computational burden of the host 100 may increase, and an amount of data input/output between the host 100 and the plurality of storage devices 201 to 203 may increase.

For example, when a vector data item (corresponding to a raw data item stored in a first storage device 201) is stored in a second storage device 202, and when the raw data item is updated, the host 100 may also update the vector data item. To update the vector data item, the host 100 may load the vector data item stored in the second storage device 202, may modify the loaded vector data item, and may then provide the modified vector data item to the second storage device 202.

In addition, when the host 100 searches for a vector data item having a vector, similar to a query vector in the second storage device 202, the host 100 may acquire a raw data item corresponding to the searched vector data item from the first storage device 201.

As in the examples above, when the raw data and the vector data are distributed and stored in the plurality of storage devices 201 to 203, an input/output amount of data between the host 100 and the plurality of storage devices 201 to 203 may increase.

According to an embodiment, each or at least one of the storage devices 201 to 203 may store raw data and vector data corresponding to the raw data, and may search for the raw data using the vector data. According to an embodiment, computational burden of the host 100 may be offloaded, and an input/output amount of data between the host 100 and the plurality of storage devices 201 to 203 may be reduced.

In addition, according to the embodiment described below, performance of storing raw data and vector data and performance of searching similar data based on a query may be improved.

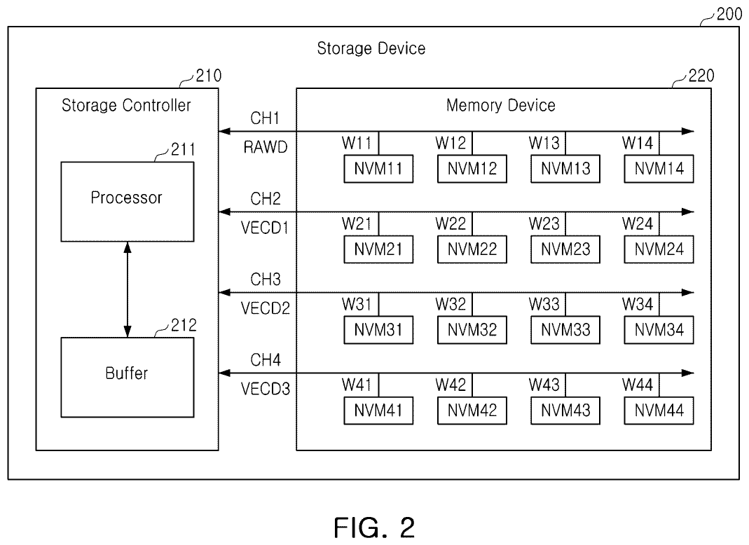

FIG. 2 illustrates a storage device according to an embodiment.

A storage device 200 of FIG. 2 may correspond to any of the plurality of storage devices 201 to 203 described with reference to FIG. 1. The storage device 200 may include a storage controller 210 and a memory device 220.

The storage controller 210 may control an overall operation of the storage device 200. For example, the storage controller 210 may store data in the memory device 220 in response to (or related to) a request from a host 100, as described with reference to FIG. 1, and may provide the data stored in the memory device 220 to the host 100 in response to a request from the host 100.

When the memory device 220 includes a flash memory, the flash memory may include a 2D NAND memory array or a 3D (or vertical) NAND (VNAND) memory array. As another example, the storage device 200 may include various other types of non-volatile memories. For example, various types of memories, such as a magnetic RAM (MRAM), a spin-transfer torque MRAM, a conductive bridging RAM (CBRAM), a ferroelectric RAM (FeRAM), a phase RAM (PRAM), a resistive RAM, and others may be applied to the storage device 200.

The storage controller 210 may include a processor 211 and a buffer memory 212. The processor 211 may execute firmware. The buffer memory 212 may temporarily store data provided from the host 100 or data output from the memory device 220.

The firmware may refer to software controlling the storage device 200. For example, the firmware of the storage device 200 may include a flash translation layer (FTL). For example, the FTL may convert a logical address used in the host 100 into a physical address of the memory device 220, and may perform a management operation such as garbage collection or wear leveling.

The memory device 220 may include a plurality of non-volatile memories NVM11 to NVM44. At least one of the non-volatile memories NVM11 to NVM44 may be connected to one of a plurality of channels CH1 to CH4 through a corresponding way. For example, the non-volatile memories NVM11 to NVM14 may be connected to a first channel CH1 through ways W11 to W14, and the non-volatile memories NVM21 to NVM24 may be connected to a second channel CH2 through ways W21 to W24.

In an example embodiment, each or at least one of the non-volatile memories NVM11 to NVM44 may be implemented as an arbitrary memory item that may operate according to an individual command from the storage controller 210. For example, each or at least one of the non-volatile memories NVM11 to NVM44 may be implemented as a chip or a die.

The storage controller 210 may transmit and receive signals to and from the memory device 220 through the plurality of channels CH1 to CH4. For example, the storage controller 210 may transmit commands, addresses, and data to the memory device 220 through the channels CH1 to CH4, or receive data from the memory device 220.

The storage controller 210 may select one of the non-volatile memories connected to a channel, and may transmit and receive signals to and from the selected non-volatile memory through the channel. The storage controller 210 may transmit commands, addresses, and data to the selected non-volatile memory through the channel, or receive data from the selected non-volatile memory through the channel.

The storage controller 210 may transmit and receive signals to and from the memory device 220 in parallel through different channels. For example, the storage controller 210 may transmit a command to the memory device 220 through the first channel CH1 while transmitting a different command to the memory device 220 through the second channel CH2. In addition, the storage controller 210 may receive different data from the memory device 220 through the second channel CH2 while receiving data from the memory device 220 through the first channel CH1.

Each or at least two of the non-volatile memories (connected to the storage controller 210 through the same channel) may perform internal operations in parallel. For example, the storage controller 210 may sequentially transmit a command and an address to the non-volatile memories NVM11 to NVM14 through the first channel CH1. When the command and the address are transmitted to the non-volatile memories NVM11 to NVM14, each or at least two of the non-volatile memories NVM11 to NVM14 may perform an operation according to the command in parallel.

FIG. 2 illustrates that the memory device 220 communicates with the storage controller 210 through four channels and includes four non-volatile memories connected to each or at least one of the channels of the memory device 220. However, the present disclosure is not limited to the above example embodiment, and the number of channels and the number of non-volatile memories connected to one channel may be variously changed.

According to an embodiment, non-volatile memories connected to the same channel may be grouped into one memory group. In the example of FIG. 2, the memory device 220 may include four memory groups respectively corresponding to the first channel CH1, the second channel CH2, the third channel CH3, and the fourth channel CH4.

According to an embodiment, the storage controller 210 may store raw data and vector data corresponding to the raw data in different memory groups.

For example, when raw data RAWD is received externally, the raw data RAWD may be buffered in the buffer memory 212. The processor 211 may generate different types of vector data VECD1, VECD2, VECD3 based on the raw data RAWD buffered in the buffer memory 212. The generated vector data VECD1, VECD2, VECD3 may be buffered in the buffer memory 212. The processor 211 may control the memory device 220 such that the raw data RAWD and the vector data VECD1, VECD2, VECD3 buffered in the buffer memory 212 may be each stored in different memory groups.

According to an embodiment, the raw data RAWD and the vector data VECD1, VECD2, VECD3 may be provided to the memory groups in parallel through the different channels CH1 to CH4, and may be simultaneously written in the memory groups. Therefore, storage performance (throughput) of the raw data RAWD and the vector data VECD1, VECD2, VECD3 may be improved.

In addition, the storage controller 210 may control the memory device 220 to simultaneously read the raw data RAWD and the vector data VECD1, VECD2, VECD3 stored in the plurality of memory groups. Simultaneously reading the raw data RAWD and the vector data VECD1, VECD2, VECD3 may shorten a time period for searching for a vector close to a query vector and outputting raw data corresponding to the vector data.

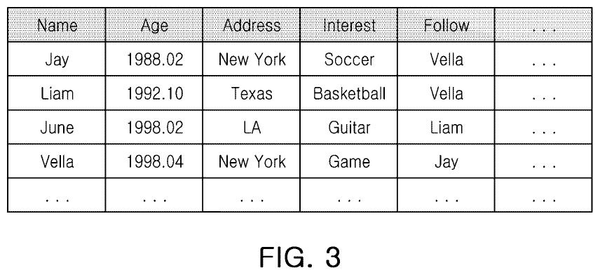

Hereinafter, example raw data and example vector data will be described with reference to FIGS. 3 to 5B.

FIG. 3 illustrates an example of raw data.

Raw data may be unprocessed original information. For example, raw data may include plain text. In an example of FIG. 3, raw data may include user information of a plurality of users. The user information may include text data having different attributes, such as Name, Age, Address, Interest, Follow, and the like of the plurality of users.

The raw data may be divided into a plurality of raw data items. For example, one raw data item may include information such as Name, Age, Address, Interest, Follow, and the like of one user, as shown in FIG. 3.

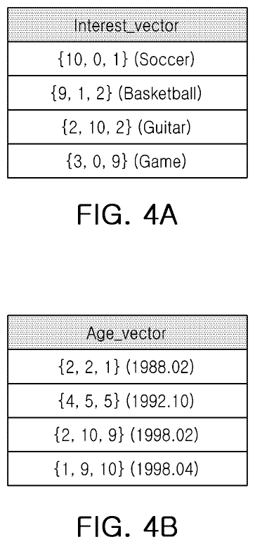

In an embodiment, vector data related to the raw data may be generated to effectively search for a user who satisfies a condition, among the plurality of users. FIG. 4A and 4B illustrate examples of vectors of different types (vector data).

Vector data may refer to data in which information is expressed in numerical form. For example, vector data may include vector data items. A vector data item may include a multidimensional vector representing an attribute or a relationship of a raw data item. For example, a word in a text may be converted into a vector that capture semantic meaning using vector embedding. The vector data items may make it easier to compare, analyze, and calculate similarities between raw data items.

FIG. 4A illustrates an interest vector “Interest_vector” to which interest data included in the raw data items of FIG. 3 is converted. Text items such as ‘Soccer,’ ‘Basketball,’ ‘Guitar,’ and ‘Game’ in FIG. 3 may be encoded into vectors such as {10, 0, 1}, {9 , 1, 2}, {2, 10, 2}, and {3, 0, 9} using an algorithm or a model designed to capture semantic meaning.

Texts with similar meanings may be mapped to spatially closer vectors. For example, a distance between vectors of ‘Soccer’ and ‘Basketball’ may be closer than a distance between vectors of ‘Soccer’ and ‘Guitar’ or a distance between vectors ‘Soccer’ and ‘Game.’

Referring to FIG. 4B, an age vector “Age_vector” to which age data included in the raw data items of FIG. 3 is converted is illustrated. The texts such as ‘1988.02’, ‘1992.10,’ ‘1998.02,’ and ‘1998.04’ in FIG. 3 may be encoded into vectors such as {2, 2, 1}, {4, 5, 5}, {2, 10, 9}, and {1, 9, 10}. In the example of FIG. 4B, a distance between vectors of closer ages may be closer than a distance between vectors of farther ages.

In an embodiment, a vector data item may include one vector corresponding to a raw data item. In an embodiment, a vector data item may further include at least one link. The at least one link may further include a position of a vector, associated with the vector, a distance from a vector, associated with the vector, a gradient from a vector, associated with the vector, or the like. For example, a link may connect a different vector nearest to the vector.

When a query is received externally, a storage device may convert the query into a query vector, and may retrieve a vector nearest to the query vector, among vectors included in vector data items.

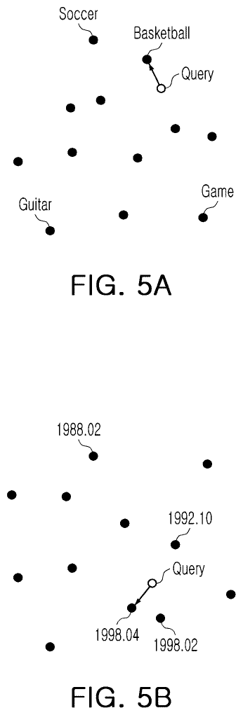

FIGS. 5A and 5B illustrate examples of vector spaces of different types.

Vectors having the same type may be represented in the same vector space. In example vector spaces of FIGS. 5A and 5B, the closer a distance between two vectors, the higher similarity between the two vectors.

FIG. 5A illustrates a case in which the interest vectors of FIG. 4A are represented in a vector space. In an example of FIG. 5A, a distance between vectors of ‘Soccer’ and ‘Basketball’ may be closer than a distance between vectors of ‘Soccer’ and ‘Guitar’ or a distance between vectors ‘Soccer’ and ‘Game.’

In an embodiment, a query may be converted into an interest vector. For example, the storage device 200 (as described with reference to FIG. 2) may receive a query including raw data for a user, and, to recommend other users having an interest, similar to an interest of the user, may convert the query into an interest vector. FIG. 5A illustrates a query vector “Query” in a vector space.

The storage device 200 may search a vector space including a plurality of interest vectors, and may find an interest vector nearest to the query vector, for example, ‘Basketball.’ The storage device 200 may output the interest vector nearest to the query vector externally.

FIG. 5B illustrates a case in which the age vectors of FIG. 4B are represented in a vector space. A distance between vectors of closer ages may be closer than a distance between vectors of farther ages.

As in the interest vectors, a query may be converted into an age vector. A storage device 200 may search a vector space including a plurality of age vectors, and find an age vector nearest to a query vector, for example, ‘1998.04.’ The storage device 200 may output the age vector nearest to the query vector externally.

FIGS. 3 to 5B show raw data and vector data by illustrating structured raw data and vector data corresponding to the raw data. However, the present disclosure is not limited to the above example embodiments. For example, raw data may include unstructured data such as image data or document data, raw data items may be generated by dividing the data to have a predetermined size, and vector data may be generated based on the raw data items.

According to an embodiment, the raw data items (described with reference to FIG. 3), the interest vector data items (described with reference to FIG. 4A), and the age vector data items (described with reference to FIG. 4B) may be stored in different memory groups in the storage device 200 described with reference to FIG. 2. For example, raw data items and vector data items associated with the raw data items and having different attributes may be stored in different memory groups. In addition, the raw data items and the vector data items having different attributes may be mapped to the same logical address.

According to an embodiment, when raw data item and vector data items (associated with the raw data item) are mapped to the same logical address, the storage device 200 may quickly search for data. In addition, a capacity of mapping data for associating raw data items and vector data items required in the storage device 200 may not increase significantly.

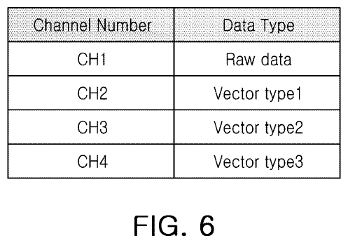

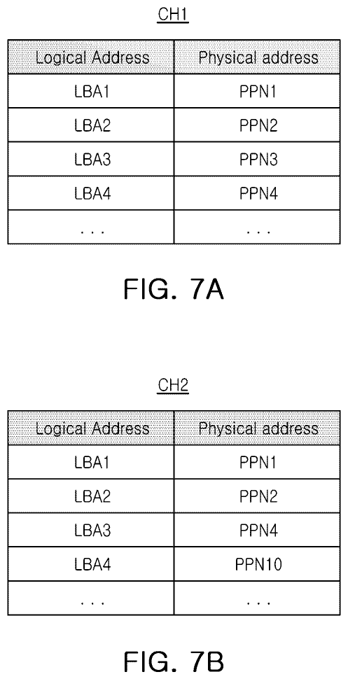

Hereinafter, address mappings of a storage device of the present disclosure may be described with reference to FIGS. 6 to 7B.

FIG. 6 illustrates a first mapping table of a storage device according to an embodiment.

According to an embodiment, a first mapping table may represent a relationship between channels CH1, CH2, CH3, and CH4 and data types. For example, a memory group corresponding to a first channel CH1 may be mapped to raw data. In addition, a memory group corresponding to a second channel CH2, a memory group corresponding to a third channel CH3, and a memory group corresponding to a fourth channel CH4 may be mapped to vector data of first to third types, respectively.

FIGS. 7A and 7B illustrate second mapping tables of a storage device according to an embodiment.

Second mapping tables may map a logical address used in the host 100 and a physical address used in a memory device 220. In an embodiment, the storage controller 210 may define a logical address space and a physical address space respectively corresponding to a plurality of memory groups connected to different channels. In addition, the second mapping tables may map a logical block address LBA and a physical page number PPN for each channel. Mapping between the logical address and the physical address may be referred to as “address mapping”.

FIG. 7A illustrates a second mapping table of a first memory group associated with a first channel CH1. FIG. 7B illustrates a second mapping table of a second memory group associated with a second channel CH2.

According to an embodiment, the same logical address in the first memory group and the second memory group may be allocated to data associated with each other. The data associated with each other does not have to be allocated to the same physical address. In examples of FIGS. 7A and 7B, the address mapping may be different for each memory group.

The first mapping table and the second mapping tables (described with reference to FIG. 6, FIGS. 7A and 7B) may be stored in the buffer memory 212 of the storage device 200, as described with reference to FIG. 2.

According to an embodiment, an amount of map data to be additionally required in mapping a raw data item and a plurality of vector data items, which are associated with the raw data item, to the same logical address may be small. Specifically, the number of memory groups included in the storage device 200 may be significantly smaller than the number of logical addresses. Therefore, a first mapping table for associating raw data items and vector data items may occupy a much smaller data capacity than second mapping tables for address mapping.

According to an embodiment, by mapping a raw data item and a plurality of vector data items, which are associated with the raw data item, to the same logical address, capacity burden of a buffer memory 212 may be reduced, and rapid data search may be performed.

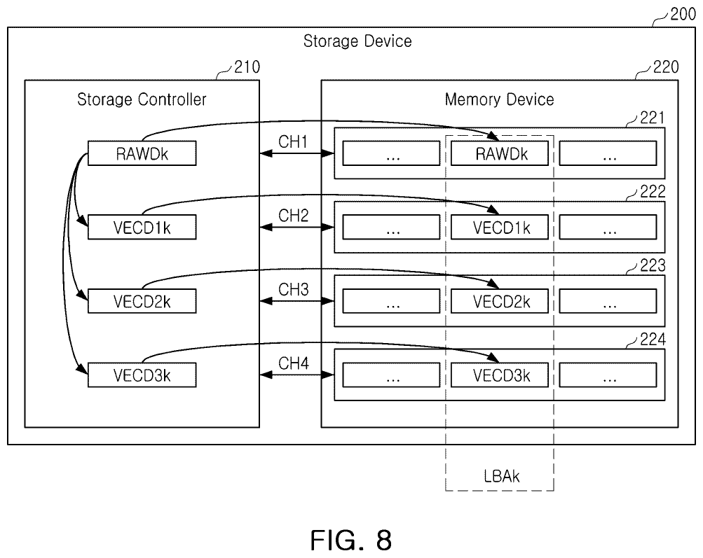

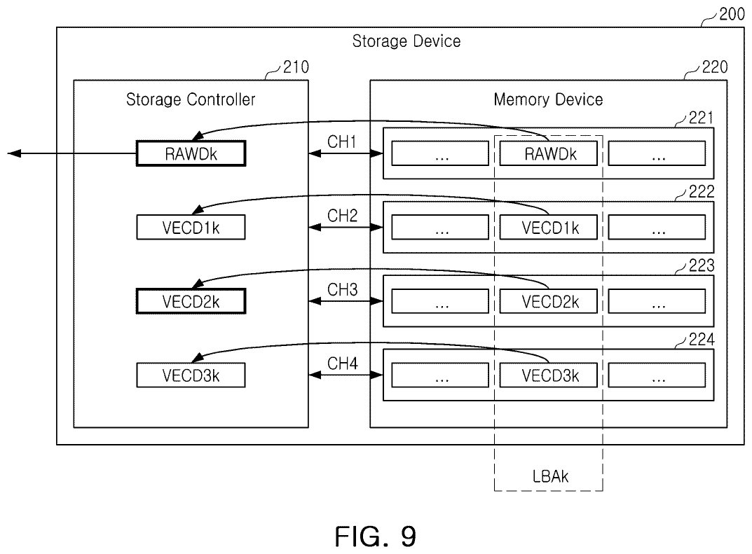

Hereinafter, data storage and search operations of a storage device according to an embodiment will be described in detail with reference to FIGS. 8 and 9.

FIG. 8 illustrates a data storage operation of a storage device according to an embodiment.

A storage device 200 of FIG. 8 may correspond to the storage device 200 described with reference to FIG. 2. The storage device 200 may include a storage controller 210 and a memory device 220. FIG. 8 illustrates logical storage spaces of a plurality of memory groups 221, 222, 223, and 224 that may be included in the memory device 220.

The storage controller 210 may receive a raw data item RAWDk corresponding to a k^{th} logical address LBAk from the host 100, as described with reference to FIG. 1. In an embodiment, a host 100 may perform generation of a plurality of raw data items by dividing raw data.

The storage controller 210 may perform vector embedding on the raw data item RAWDk to generate vector data items VECD1k, VECD2k, VECD3k of different types. For example, the vector data items VECD1k, VECD2k, VECD3k of different types may include vectors of different attributes. When the raw data item RAWDk includes a raw data item, as described with reference to FIG. 3, at least one of the vector data items VECD1k, VECD2k, VECD3k may be any one of different age vectors, address vectors, interest vectors, or follower vectors.

The storage controller 210 may map at least one of the generated vector data items VECD1k, VECD2k, VECD3k to a logical address (LBAk), identical to those of the raw data item RAWDk. Then, the storage controller 210 may determine a memory group in which the raw data item RAWDk and the vector data items VECD1k, VECD2k, VECD3k are to be stored according to a data type of at least one of the raw data item RAWDk and the vector data items VECD1k, VECD2k, VECD3k. For example, to determine the memory group, the storage controller 210 may refer to a first mapping table, as described with reference to FIG. 6.

The storage controller 210 may control the memory device 220 such that the raw data item RAWDk and the vector data items VECD1k, VECD2k, VECD3k are stored in different memory groups 221, 222, 223, and 224. The raw data item RAWDk and the vector data items VECD1k, VECD2k, VECD3k may be provided to the memory groups 221, 222, 223, and 224 in parallel through different channels CH1, CH2, CH3, and CH4, and may be simultaneously written in the memory groups 221, 222, 223, and 224.

According to an embodiment, since an operation of generating vector data items of various types based on a raw data item in a vector database system may be offloaded to a storage device, an input/output amount of data between a CPU and the storage device may be reduced. In addition, since the storage device may simultaneously write a raw data item and vector data items associated with the raw data item, storage performance of a vector database may be improved.

FIG. 8 illustrates an embodiment in which one memory group is respectively allocated to raw data and different types of vector data. However, the present disclosure is not limited to the above example embodiment, and the number or ratios of memory groups respectively allocated to the raw data and the different types of vector data may be changed.

For example, among the four memory groups 221, 222, 223, and 224, the storage device 200 may allocate two memory groups to the raw data and one memory group to each of the two different types of vector data. The number or ratios of the memory groups respectively allocated to the raw data and the different types of vector data may be changed depending on importance of data or selection by a user. For example, the more important the data is, the fewer number of memory groups may be allocated to the raw data such that various types of vector data may be stored.

FIG. 9 illustrates a data search operation of a storage device according to an embodiment.

A storage device 200 of FIG. 9 may correspond to the storage device 200 described with reference to FIG. 8.

When query data is received from a host 100, a storage controller 210 may search for raw data associated with the query data, using vector data stored in a memory device 220, and may output a searched raw data to the host 100.

The storage controller 210 may perform vector embedding on the query data to generate a query vector, and may find a neighboring vector nearest to the query vector. To find the neighboring vector of the query vector, the storage controller 210 may read the vector data from the memory device 220.

According to an embodiment, the storage controller 210 may perform address conversion for each or at least one of memory groups 221, 222, 223, and 224, based on one logical address (LBAk), to find a physical address of a region in which a raw data item RAWDk and vector data items VECD1k, VECD2k, VECD3k, which are associated with the raw data item RAWDk, are stored. In addition, the storage controller 210 may provide read requests to each or at least one of the memory groups 221, 222, 223, and 224 in parallel, and may simultaneously acquire the raw data item RAWDk and the vector data items VECD1k, VECD2k, VECD3k, associated with the raw data item RAWDk, from each or at least one of the memory groups 221, 222, 223, and 224.

According to an embodiment, when the storage controller 210 finds a neighboring vector of the query vector in the vector data items VECD1k, VECD2k, VECD3k obtained from the memory device 220, the storage controller 210 may output the raw data item RAWDk obtained from the memory device 220 to the host 100.

For example, depending on a type of the query vector, the neighboring vector of the query vector may be found based on the vector data items stored in a third memory group 223. For example, when the third memory group 223 includes an interest vector, as described with reference to FIG. 4A, and the query vector is an interest vector, the neighboring vector may be searched for in the third memory group 223. When a second vector data item VECD2k among the vector data items stored in the third memory group 223 includes a neighboring vector of the query vector, the row data item RAWDk associated with the second vector data item VECD2k may be output.

According to an embodiment, when the storage controller 210 acquires a vector data item from the memory device 220 to find a neighboring vector of the query vector, the storage controller 210 may acquire row data associated with the vector data item at the same time. The storage controller 210 may output an already acquired raw data after finding the neighboring vector of the query vector, such that a time period for reading the raw data may be saved. Therefore, search performance of the data may be improved.

In the example embodiment of FIGS. 6 to 9, to associate a raw data item and vector data items, logical addresses of the raw data item and the vector data items, associated with each other, are matched. However, the present disclosure is not limited to the above example embodiment.

For example, a storage device may not match logical addresses of the raw data item and the vector data items, associated with each other, and may insert the logical address of the associated raw data item into each or at least one of the vector data items. When a neighboring vector of a query vector is found, the storage device may find the logical address of the associated raw data item in the vector data items including the neighboring vector, and may acquire the raw data item from the memory device using the logical address and the first mapping table.

When the storage controller 210 reads all vector data items stored in the storage device 220 to find a neighboring vector of the query vector and compares a distance between all vectors in a vector space and the query vector, excessive resources may be consumed. In order for the storage controller 210 to consume less resources and quickly find a neighboring vector, the vector data item may further store link information together with a vector.

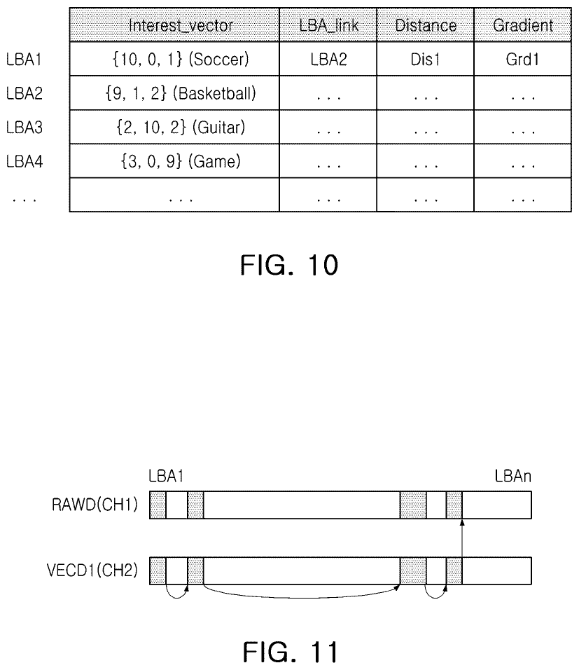

FIG. 10 illustrates an example of vector data according to an embodiment.

Referring to FIG. 10, vector data may include interest vectors, as described with reference to FIG. 4A. Specifically, the vector data may include a plurality of vector data items, such as an interest vector (Interest_vector), a link (LBA_link), a distance (Distance), and a gradient (Gradient).

At least one of the vector data items may be mapped to logical addresses LBA1, LBA2, LBA3, LBA4. The link may include information for connecting a vector included in the vector data item and an associated vector associated with the vector. For example, the link may include a logical address corresponding to a vector data item including the associated vector. And, at least one of the vector data items may further include a distance and slope information between the vector and the associated vector.

The storage controller 210 may search for a neighboring vector of a query vector with reference to vector data items stored in the memory device 220.

FIG. 11 illustrates a data search process of a storage device according to an embodiment.

FIG. 11 illustrates a logical address space of a first memory group associated with a first channel CH1 and a logical address space of a second memory group associated with a second channel CH2. Raw data RAWD may be stored in the first memory group, and vector data VECD1 (associated with the raw data RAWD) may be stored in the second memory group.

A plurality of logical addresses LBA1 to LBAn may be allocated to the logical address space of the first memory group and the logical address space of the second memory group. The same logical address may be allocated to a raw data item and a vector data item associated with the raw data item. In addition, the raw data item and the vector data item to which the same logical addresses are allocated may be read at the same time.

In an embodiment, to find a neighboring vector nearest to a query vector, a storage controller 210 may search for the logical address space from a first logical address LBA1. The storage controller 210 may not search entirely the logical address space to find the neighboring vector of the query vector.

According to an embodiment, the storage controller 210 may acquire a link from a vector data item read based on a certain logical address, and may determine a logical address to be read in the next order with reference to the link. When the logical address to be read in the next order is determined (by the storage controller 210) with reference to the link, a read operation of some logical addresses may be skipped. The storage controller 210 may search for a neighboring vector of the query vector without reading all vector data items. FIG. 11 illustrates that an example region to be read to search for a neighboring vector in the logical address space is shaded.

According to an embodiment, the storage controller 210 may control a memory device 220 to simultaneously read a region corresponding to the same logical addresses of the first memory group and the second memory group. Therefore, the vector data VECD1 and the raw data RAWD associated with the vector data VECD1 may be simultaneously acquired by the storage controller 210. When the storage controller 210 determines a neighboring vector, raw data corresponding to the neighboring vector may be loaded into the storage controller 210. When the neighboring vector is determined, the storage controller 210 may output raw data corresponding to the neighboring vector as a response to a query.

Whether vectors among vectors included in a vector space are connected to each other may be determined according to a vector indexing algorithm. For example, the associated vector of the vector may be determined according to the vector indexing algorithm, and the link included in the vector data item may be determined.

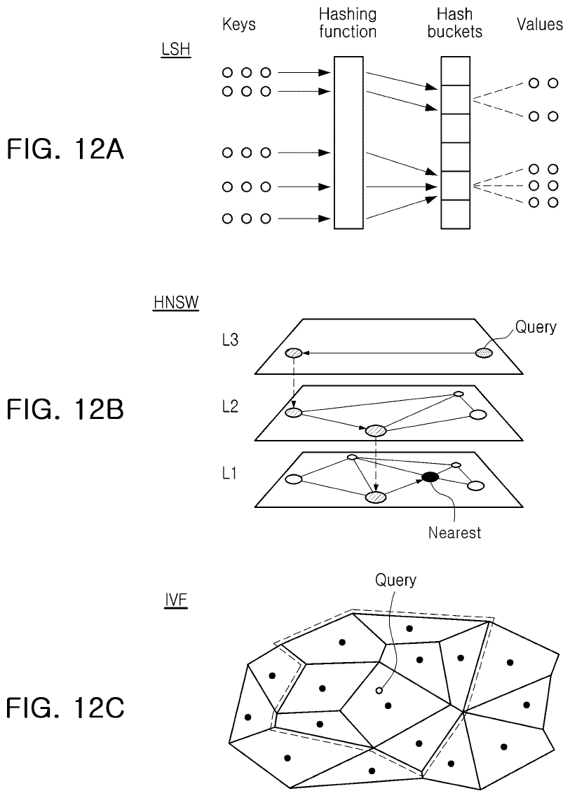

FIGS. 12A to 12C illustrate examples of a vector indexing algorithm.

A vector indexing algorithm may be used to efficiently perform nearest neighbor search in a vector database.

FIG. 12A illustrates a locality-sensitive hashing (LSH) algorithm.

Referring to FIG. 12A, a plurality of vectors may be mapped to a plurality of hash buckets using a plurality of hashing functions. The hashing functions may be designed such that vectors in similar locations are mapped to the same hash bucket with high probability. To search for a nearest neighboring vector using a query vector, it may be determined to which hash bucket the query vector is mapped, based on the hashing functions. Then, only vectors included in the hash bucket may be compared with the query vector, such that the nearest neighboring vector is searched.

FIG. 12B illustrates a hierarchical navigable small world graphs (HNSW) algorithm.

Referring to FIG. 12B, in an HNSW algorithm, vectors may be indexed based on a graph-based structure in which nodes represent the vectors, and edges connect neighboring vectors based on proximity.

The graph may include vectors included in a plurality of layers L1 to L3 and edges connecting the vectors. A neighboring vector nearest to a query vector may be searched from an uppermost layer L3. When the vector nearest to the query vector is searched in a current layer, search for a nearest vector centered on the nearest vector may be repeated in a lower layer. Then, the nearest neighboring vector may be searched from a lowest vector.

FIG. 12C illustrates an inverted file indexing (IVF) algorithm.

Referring to FIG. 12C, in an IVF algorithm, similar vectors may be grouped into a cluster, a centroid of the cluster may be determined, and a vector may be allocated to the centroid, thereby allowing the vector to be indexed. A query vector and centroid vectors of clusters may be compared to search a cluster to which query belongs. In addition, among vectors included in the cluster, a neighboring vector nearest to the query may be searched.

According to an embodiment, a storage device 200 may index vectors having the same attribute using different vector indexing algorithms, to generate vector data having different types. The storage device 200 may distinguish and store the vector data having different types in different memory groups. The storage device 200 may search neighboring vectors of a query vector having the same attribute more quickly by using the vector data of different types having the same attribute.

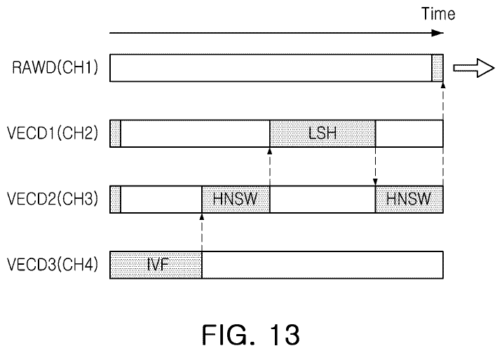

FIG. 13 illustrates a data search method of a storage device according to an embodiment.

FIG. 13 illustrates data mainly referenced over time, when searching first to fourth memory regions associated with the first channel CH1, the second channel CH2, the third channel CH3, and the fourth channel CH4 in parallel. Specifically, FIG. 13 illustrates that vector data for determining a logical address to be read in the next order, and raw data to be finally output are shaded.

The first memory region may store raw data RAWD, and the second to fourth memory regions may respectively store vectors of the same attribute and vector data VECD1 to VECD3 of different types generated using different vector indexing algorithms. For example, first vector data VECD1 may be vector data based on an LSH algorithm, second vector data VECD2 may be vector data based on an HNSW algorithm, and third vector data VECD3 may be vector data based on an IVF algorithm.

A storage controller 210 may simultaneously acquire vector data items of different types corresponding to the same logical address, may determine a vector data item having a vector nearest to a query vector, among the vector data items, and may determine a logical address to be read in the next order with reference to a link included in the vector data item.

In an example of FIG. 13, first to third vector data items respectively included in the first vector data VECD1, the second vector data VECD2, the third vector data VECD3 may be acquired from a first logical address, and a logical address to be read in the next order may be determined based on the first to third vector data items. When the third vector data item included in the third vector data has the vector nearest to the query vector, the logical address to be read in the next order may be determined with reference to a link included in the third vector data item. For example, the logical address to be read in the next order may be determined based on the IVF algorithm.

Even while searching for neighboring vectors based on the IVF algorithm, the raw data RAWD and the first vector data VECD1, the second vector data VECD2, the third vector data VECD3 may be read in parallel. In addition, among the first vector data VECD1, the second vector data VECD2, the third vector data VECD3, the vector data having the vector nearest to the query vector may be updated. In the example of FIG. 13, the storage controller 210 may search for vector data based on the IVF algorithm and then search for vector data based on the HNSW algorithm. Thereafter, the storage controller 210 may search for vector data based on the LSH algorithm, and may finally find a neighboring vector as a result of searching for vector data based on the HNSW algorithm.

When a neighboring vector is found, the storage controller 210 may output raw data item loaded into the storage controller 210, at the same time as the neighboring vector, as a response to a query.

According to an embodiment, an indexing algorithm that may search for a neighboring vector of a query vector most quickly, among a plurality of vector indexing algorithms, may be selected and changed in real time. Therefore, a speed of searching for a neighboring vector may be improved.

Referring to FIGS. 1 to 13, an embodiment has been described as an example in which a storage device generates vector data items based on a raw data item and distinguishes and stores the raw data item and the vector data items in memory groups. However, the present disclosure is not limited thereto. For example, a storage device may receive a raw data item and vector data items, generated externally, and may distinguish and store the raw data item and the vector data items in memory groups.

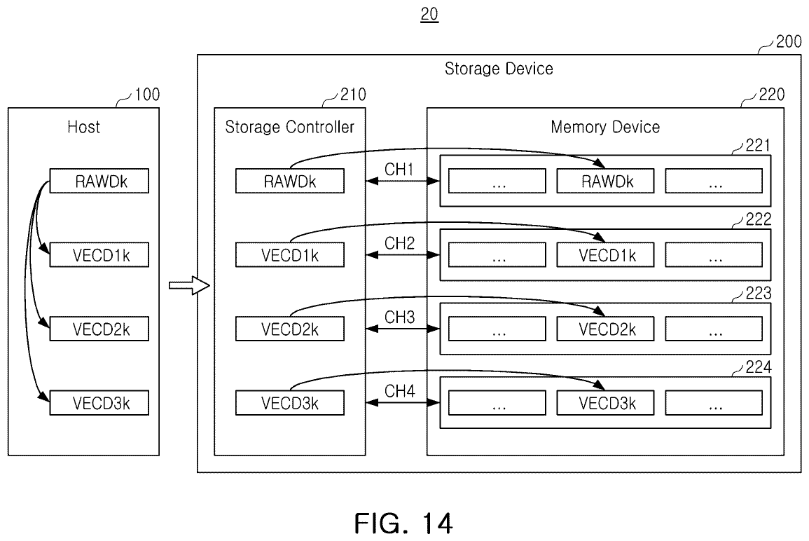

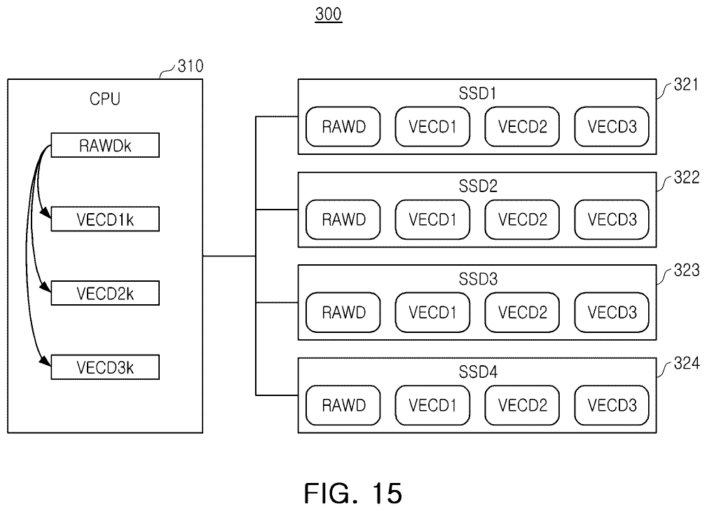

Hereinafter, a storage system according to an embodiment will be described with reference to FIGS. 14 to 15.

FIG. 14 illustrates a vector database system according to an embodiment.

A vector database system 20 of FIG. 14 may include a host 100 and a storage device 200. The storage device 200 may include a storage controller 210 and a memory device 220. The memory device 220 may include memory groups 221, 222, 223, and 224 performing data input/output with the storage controller 210 through a plurality of channels CH1 to CH4.

The host 100 may generate a raw data item RAWDk based on raw data, and may perform vector embedding on the raw data item RAWDk to generate vector data items VECD1k, VECD2k, VECD3k of different types. In an embodiment, to generate the raw data item RAWDk and the vector data items VECD1k, VECD2k, VECD3k, the host 100 may include an accelerator circuit separate from the CPU.

The storage controller 210 may receive the raw data item RAWDk and the vector data items VECD1k, VECD2k, VECD3k from the host 100, and may distinguish and store the raw data item RAWDk and the vector data items VECD1k, VECD2k, VECD3k in the different memory groups 221, 222, 223, and 224. The storage controller 210 may allocate the same logical address to the raw data item RAWDk and the vector data items VECD1k, VECD2k, VECD3k.

The storage controller 210 may receive a query vector from the host 100, and may search for a neighboring vector of the query vector. To search for the neighboring vector, the storage controller 210 may simultaneously acquire the raw data item RAWDk and the vector data items VECD1k, VECD2k, VECD3k through the different channels CH1 to CH4. When a neighboring vector is found among vectors included in the vector data items VECD1k, VECD2k, VECD3k, the acquired raw data item RAWDk may be output externally.

FIG. 15 illustrates a storage system according to an embodiment.

A storage system 300 may include a CPU 310 and a plurality of storage devices 321, 322, 323, 324. In an embodiment, the storage system 300 may be a petabyte (PB)-SSD, and the plurality of storage devices 321, 322, 323, 324 may be SSDs. Specifically, the storage system 300 may include the plurality of storage devices 321, 322, 323, 324 to provide a high-capacity storage space on a petabyte level and high-bandwidth input/output, and may include the CPU 310 that is configured to control communication between the plurality of storage devices 321, 322, 323, 324 and a host.

According to an embodiment, the CPU 310 may generate a raw data item RAWDk based on raw data, and may perform vector embedding on the raw data item RAWDk to generate vector data items VECD1k, VECD2k, VECD3k of different types.

The CPU 310 may provide the raw data item RAWDk and the vector data items VECD1k, VECD2k, VECD3k to a single storage device such that each or at least one of the storage devices 321, 322, 323, 324 may store raw data RAWD and vector data VECD1 to VECD3 associated with the raw data.

Each or at least one of the storage devices 321, 322, 323, 324 may distinguish and store the raw data RAWD and the vector data VECD1 to VECD3 in memory groups performing data input/output through different channels. For example, a storage device receiving the raw data item RAWDk and the vector data items VECD1k, VECD2k, VECD3k from the CPU 310 may allocate the same logical address to the raw data item RAWDk and the vector data items VECD1k, VECD2k, VECD3k, and may store the raw data item RAWDk and the vector data items VECD1k, VECD2k, VECD3k in different memory groups.

A storage device according to an embodiment may include memory groups capable of independently performing data input/output, and may separately store raw data and vector data by memory group, to improve performance (throughput) of a write operation and a read operation of the raw data and the vector data.

A storage device according to an embodiment may allocate the same logical address to raw data and vector data associated with the raw data, to quickly and easily search for data.

Problems to be solved by the present disclosure is not limited to the problems mentioned above, and other problems not mentioned will be clearly understood by those skilled in the art from the description below.

While example embodiments have been illustrated and described above, those skilled in the art that modifications and variations could be made without departing from the scope of the present disclosure as defined by the appended claims.

What is claimed is:

1. A storage device comprising:
a plurality of memory groups respectively including a plurality of non-volatile memories;
a storage controller configured to control the plurality of memory groups; and
a plurality of channels respectively connecting the storage controller and the plurality of memory groups,
wherein the storage controller is configured to:
generate one or more vector data items by performing vector embedding on a raw data item, and
store the raw data item and the one or more vector data items respectively in different memory groups among the plurality of memory groups.

2. The storage device of claim 1, wherein the storage controller is further configured to:
define a logical address space for at least one of the plurality of memory groups, and
allocate a same logical address to the raw data item and the one or more vector data items that are associated with the raw data item.

3. The storage device of claim 2, wherein the storage controller is further configured to store a first mapping table including a mapping of the plurality of memory groups and a plurality of data types, and
wherein the plurality of data types comprise a raw data type and one or more vector data types.

4. The storage device of claim 3, wherein the storage controller is further configured to store a second mapping table for mapping logical addresses and physical addresses of at least one of the plurality of memory groups.

5. The storage device of claim 2, wherein the one or more vector data items comprise at least one of a vector, a link to an associated vector of the vector, a distance between the vector and the associated vector, and a gradient between the vector and the associated vector.

6. The storage device of claim 1, wherein the one or more vector data items comprise a plurality of vector data items having a plurality of different vector data types.

7. The storage device of claim 6, wherein the raw data item comprises data having different attributes, and
wherein the plurality of different vector data types comprise a vector for data having different attributes.

8. The storage device of claim 1, wherein the storage controller is further configured to simultaneously write the raw data item and the one or more vector data items by controlling the plurality of memory groups.

9. The storage device of claim 1, wherein the storage controller is further configured to, in response to a query from a host, simultaneously read the raw data item and the one or more vector data items by controlling the plurality of memory groups.

10. The storage device of claim 9, wherein the storage controller comprises a buffer memory,
wherein the storage controller is further configured to:
store the raw data item and the one or more vector data items, obtained from the plurality of memory groups, in the buffer memory, and
in a state that the one or more vector data items correspond to a neighboring vector neighboring a query vector corresponding to the query, output the raw data item stored in the buffer memory to the host.

11. The storage device of claim 1, wherein the storage controller comprises an accelerator configured to perform the vector embedding.

12. A storage device comprising:
a plurality of memory groups respectively including a plurality of non-volatile memories;
a storage controller configured to control the plurality of memory groups; and
a plurality of channels respectively connecting the storage controller and the plurality of memory groups,
wherein the storage controller is configured to:
by performing vector embedding on a raw data item to generate a vector, generate a plurality of vector data items connecting the vector and a different vector based on different vector indexing methods, and
store the raw data item and the plurality of vector data items respectively in different memory groups among the plurality of memory groups.

13. The storage device of claim 12, wherein the storage controller is further configured to:
define a logical address space for at least one of the plurality of memory groups, and
allocate a same logical address to the raw data item and the plurality of vector data items that are associated with the raw data item.

14. The storage device of claim 13, wherein the storage controller is further configured to:
perform vector embedding on a query from a host to generate a query vector,
simultaneously read the raw data item and the plurality of vector data items using one logical address by controlling the plurality of memory groups, and
determine a logical address to be read in a next order, based on a vector data item including a vector nearest to the query vector among the plurality of vector data items.

15. The storage device of claim 13, wherein the plurality of vector data items comprise at least one of a vector, a logical address of an associated vector determined based on a vector indexing algorithm, a distance between the vector and the associated vector, and a gradient between the vector and the associated vector.

16. The storage device of claim 15, wherein the vector indexing algorithm is at least one of locality-sensitive hashing (LSH), hierarchical navigable small world graphs (HNSW), or inverted file indexing (IVF).

17. A storage system comprising:
at least one processor configured to perform vector embedding on a raw data item and generate one or more vector data items;
a storage device including a plurality of memory groups respectively including a plurality of non-volatile memories;
a storage controller configured to control the plurality of memory groups and
a plurality of channels respectively connecting the storage controller and the plurality of memory groups,
wherein the storage controller is further configured to:
receive the raw data item and the one or more vector data items from the at least one processor, and
store the raw data item and the one or more vector data items respectively in different memory groups among the plurality of memory groups.

18. The storage system of claim 17, wherein the storage controller is further configured to:
define a logical address space for at least one of the plurality of memory groups, and
allocate a same logical address to the raw data item and the one or more vector data items that are associated with the raw data item.

19. The storage system of claim 17, wherein the one or more vector data items comprise a plurality of vector data items generated by connecting a vector generated by performing vector embedding with a different vector, based on different vector indexing methods, and
wherein the plurality of vector data items comprise a link between the vector and the different vector.

20. The storage system of claim 17, wherein the storage system is a petabyte-solid state drive (PB-SSD).
